(19) United States
(12) Patent Application Publication
(10) Pub. No.: US 2006/0291116 A1
(43) Pub. Date: Dec. 28, 2006

(54) Power supply load selection control circuit

(75) Inventor: Michael Chen, Taipei Hsien (TW)

Correspondence Address: BIRCH STEWART KOLASCH & BIRCH, PO BOX 747, FALLS CHURCH, VA, 22040-0747, US

(73) Assignee: TOPOWER COMPUTER INDUSTRIAL CO., LTD.

(21) Appl. No.: 11/158,085

(22) Filed: Jun. 22, 2005

(51) Int. Cl. H02H 3/00

(52) U.S. Cl. 361/78

(57) ABSTRACT

A power supply load selection control circuit is adopted for use on a power supply which has a maximum power utilization limit. The power supply has a power protection circuit which includes a power reference circuit to provide a limited power value. The limited power value is determined via reference elements located on the power reference circuit to generate different reference power values and a switch electrically connected to the reference element circuits. Users can determine the limited power value according to load requirements to select the optimum power of the power supply and achieve protection purpose.

### FIELD OF THE INVENTION

The present invention relates to a power supply load selection control circuit and particularly to a load selection control circuit adopted for use on a power supply which has a maximum power utilization limit to enable users to selectively switch and define the required maximum power utilization limit.

### BACKGROUND OF THE INVENTION

Nowadays user's demand for the performance of computer systems increases constantly. Power supply for system CPU and peripheral devices also has to provide a greater power output. Design of the power supply has to take into account of hazard or effect of electricity to human body. Hence there is a limited energy reference for output power (the maximum output power (Max VA) of the power supply mostly is 240 VA under the present specification. Hence for output of 12V, the maximum output current is limited to 20 A). For instance, in SSI or UL standards, there is an Energy Hazard standard for the power supply of electric devices. It limits the maximum output power of the power supply to 240 VA to protect the safety of general computer users.

However, as the operation speed of the computer system increases, the connecting peripheral devices also increase. To meet the requirements of high end users, more electric output ports are needed. Each of the electric output ports has to add a power protection circuit. This creates problems in the fabrication of the power supply, as design of the power protection circuit is difficult. Moreover, different device types require different designs of power protection circuit based on different power. This becomes a heavy burden to power supply manufacturers. In addition, for the high end users, the power required for the high end peripheral devices often is greater than the protection standard. As a result, many high end users prefer the power supply without the protection function. Hence many power supply manufacturers have to design and provide power supply with a greater power but without the protection function to meet market requirements. This also increases the design and fabrication costs. It is not economic effective.

### SUMMARY OF THE INVENTION

Therefore the primary object of the present invention is to solve the aforesaid disadvantages. The invention aims to provide a power supply load selection control circuit that enables users to selectively determine by themselves different power limit protection functions according to power requirements. Hence power supply manufacturers can produce a single type of uniform product based on a desired power, and users can configure high power peripheral devices without changing different types of power supply.

In order to achieve the foregoing object, the invention is adopted for use on a power supply which has a maximum power utilization limit. The power supply power protection circuit according to the invention provides a limited power value through a power reference circuit. The limited power value is selected and determined through reference elements on the power reference circuit that generate varying power reference values and a switch electrically connected to the reference element circuit. Users can determine the limited power value according to load requirements to optimize the power of the power supply and achieve the protection purpose.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a circuit diagram of a first embodiment of the present invention.

FIG. 2 is a schematic view of the switch configuration of the first embodiment of the present invention.

FIG. 3 is a circuit diagram of a second embodiment of the present invention.

FIG. 4 is a schematic view of the switch configuration of the second embodiment of the present invention.

### DETAILED DESCRIPTION OF THE PREFERRED EMBODIMENTS

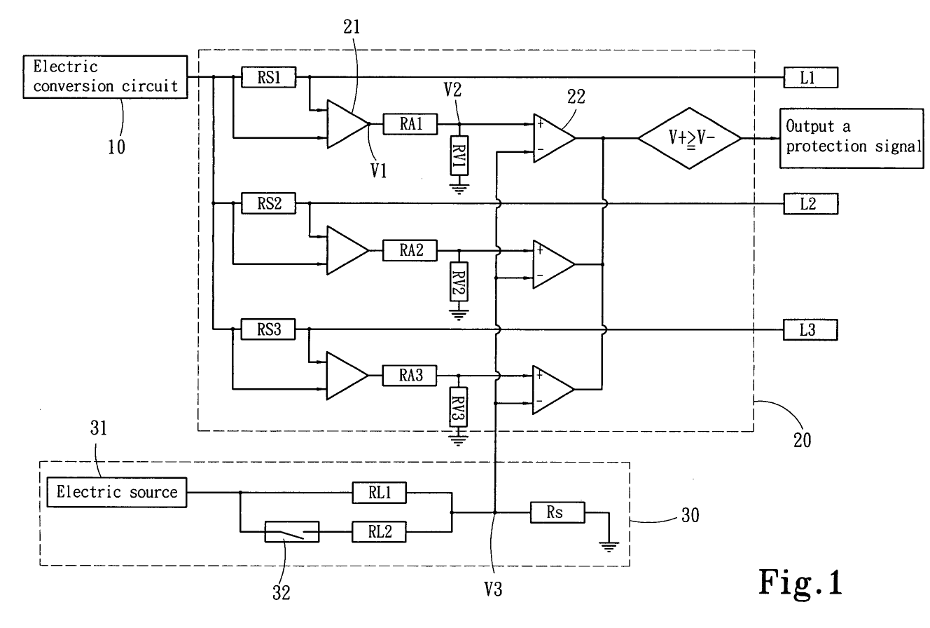

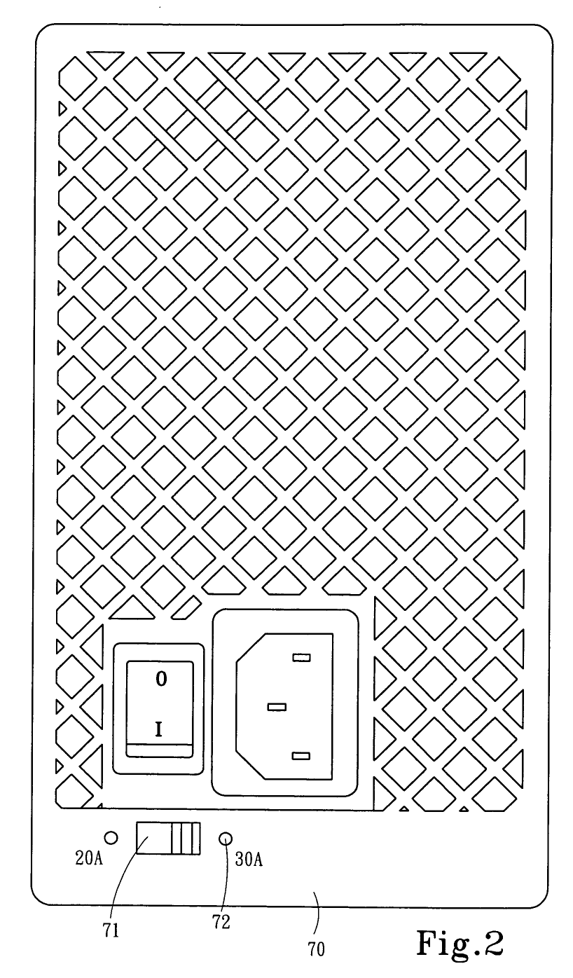

Please refer to FIGS. 1 and 2 for the circuit diagram of the invention. The invention provides a selection control circuit for loads L1-L3 of a power supply. The power supply includes at least an electric conversion circuit 10 which outputs DC to drive at least one of the loads L1-L3 (in an embodiment shown in the drawings, three sets of DC are output to drive three loads L1-L3) and a power protection circuit 20 connecting electrically to the electric conversion circuit 10. The DC that drives the loads L1-L3 has a use power value V2 which is compared with a limited power value V3 by the power protection circuit 20 to output a protection signal. The limited power value V3 of the power protection circuit 20 is provided by a power reference circuit 30. The power reference circuit 30 includes an electric source 31 which provides reference electricity, a plurality of reference elements connecting to the electric source 31 to generate a plurality of limited power values V3, and a switch 32 electrically connected to the reference element circuit ( [symbol] [symbol] ) to determine the limited power value V3 input to the power protection circuit 20.

The power reference circuit 30 for the electric source 31 according to the invention adopts a constant voltage. The power reference circuit 30 is know in the art and has many selections. The invention chooses one of them, such as the electric source 31 with a constant current or a power reference circuit 30 with an equivalent circuit. In one embodiment of the invention, the power protection circuit 20 includes a signal amplifier 21 (presumed to have amplification of 35 times) and a power comparator 22 according to each DC (presumed to be 12V) output to drive the load L1-L3 circuits. The circuits have serial resistors RS1-RS3 (presumed to have an average resistance of 0.002 Ω). When the DC passes through the resistors RS1-RS3, a potential difference is generated. The potential difference is coupled to the + − ends of the signal amplifier 21 and is amplified to get a detected voltage V1. Through sampling resistors RA1-RA3 (presumed to be 2 KΩ) and voltage splitting ( [symbol] ) of grounded component voltage resistors ( [symbol] ) RV1-RV3 (presumed to be 15 KΩ), a power value V2 is obtained. The power value V2 is connected to a V+ end of the power comparator 22 to become an input signal. The power comparator 22 has a V− end connecting to the power reference circuit 30. The power reference circuit 30 of the invention includes an electric source 31 (presumed to be 2.5 VDC) which passes through power resistors RL1 and RL2 (presumed two maximum power limited modes, with a maximum current limit of 20 A for RL1=1 KΩ, and maximum current limit of 30 A for RL2=510 KΩ), and a component voltage resistor Rs (presumed to be 1 KΩ, the component voltage resistor Rs may be a single power resistor or jointly connected resistors. It is an equivalent circuit. The following discussion is based on two power resistors RL1 and RL2 connecting in parallel). The input signal of the limited power value V3 input to the V− end of the power comparator 22 is determined by the switch 32. The switch 32 may be manually controlled or automatically switched by software definition. If the manual control is adopted, an external switch 71 is provided to do switch control. The switch 71 is located on a face panel 70 of the power supply. There are two indication lights 72 on two sides of the switch 71 to indicate the power conditions after switch is done. For automatic switch by software definition, the switch 32 may be a transistor. And the power protection circuit 20 and the power reference circuit 30 of the invention may be integrated to an IC. This is the design of an equivalent circuit, details are omitted.

### EXAMPLE 1

Based on the presumed values set forth above, if a user selects the maximum operation current 20 A as the required power protection limit after taking into account of the loads L1-L3, the switch 32 is in an open condition, the input electricity of the electric source 31 merely passes through RL1 without passing through RL2, and the input signal of the limited power value V3 at the receiving end V− of the power comparator 22 may be calculated as follow:
V3=constant voltage(2.5V)×(power resistor RL1=1K Ω/power resistor RL1=1KΩ+component voltage resistor Rs=1KΩ)=1.25V.

The input signal of the use power value V2 at the receiving end V+ of the power comparator 22 may be calculated as follow:
V1=serial resistor RS1(0.0022 Ω)×operation current (20 A)×amplification times(35)=1.4V.
V2=V1×(RA1/RA1+RV1)=1.4×(15 k/15 k+2 k)=1.235V.

Based on above calculations, when the operation current is equal to or smaller than 20 A, the input signal (1.235V) of the use power value V2 at the receiving end V+ of the power comparator 22 is smaller than the input signal (1.25V) of the limited power value V3 at the receiving end V− of the power comparator 22. And the output signal of the power comparator 22 is LOW and does not actuate the protection circuit of the power supply. Hence the power supply functions continuously.

### EXAMPLE 2

Compare with the example 1, if the output operation current exceeds 20 A due to abnormal condition of the power supply, such as 20.25 A, then V1=1.4175V, and V2 is 1.2507V; and the input signal (1.2507V) of the use power value V2 at the receiving end V+ of the power comparator 22 is greater than the input signal (1.25V) of the limited power value V3 at the receiving end V− of the power comparator 22. The output signal of the power comparator 22 is HIGH and activates the protection circuit of the power supply. The power supply stops operation to avoid generation of hazard energy.

### EXAMPLE 3

Based on the presumed values set forth above, if a user selects the maximum operation current 30 A as the required power protection limit after taking into account of the loads L1-L3, the switch 32 is in a closed condition. The input electricity of the electric source 31 passes through RL2 and RL1 at the same time, and the input signal of the limited power value V3 at the receiving end V− of the power comparator 22 may be calculated as follow:
V3=constant voltage (2.5V)×(parallel power resistor RL1//RL2=337.75 Ω/power resistor RL1=1KΩ+component voltage resistor Rs=1KΩ)=1.869V.

The input signal of the use power value V2 at the receiving end V+ of the power comparator 22 may be calculated as follow:
V1=serial resistor RS1(0.002 Ω)×operation current (30 A)×amplification times (35)=2.1V.
V2=V1×(RA1/RA1+RV1)=2.1×(15 k/15 k+2 k)=1.853V.

Based on above calculations, when the operation current is equal to or smaller than 30 A, the input signal (1.853V) of the use power value V2 at the receiving end V+ of the power comparator 22 is smaller than the input signal (1.869V) of the limited power value V3 at the receiving end V− of the power comparator 22. And the output signal of the power comparator 22 is LOW and does not actuate the protection circuit of the power supply. Hence the power supply functions continuously.

### EXAMPLE 4

Compare with the example 1, if the output operation current exceeds 30 A due to abnormal condition of the power supply, such as 30.28 A, and V1=2.1196V, and V2 is 1.87V; then the input signal (1.87V) of the use power value V2 at the receiving end V+ of the power comparator 22 is greater than the input signal (1.869V) of the limited power value V3 at the receiving end V− of the power comparator 22. The output signal of the power comparator 22 is HIGH and activates the protection circuit of the power supply. The power supply stops operation to avoid generation of hazard energy.

According to the examples previously discussed, it is obvious that users can determine the maximum power protection mechanism by themselves according to power requirements of the loads L1-L3 through the switch 32. Hence there is no need to prepare many different specifications of the power supply.

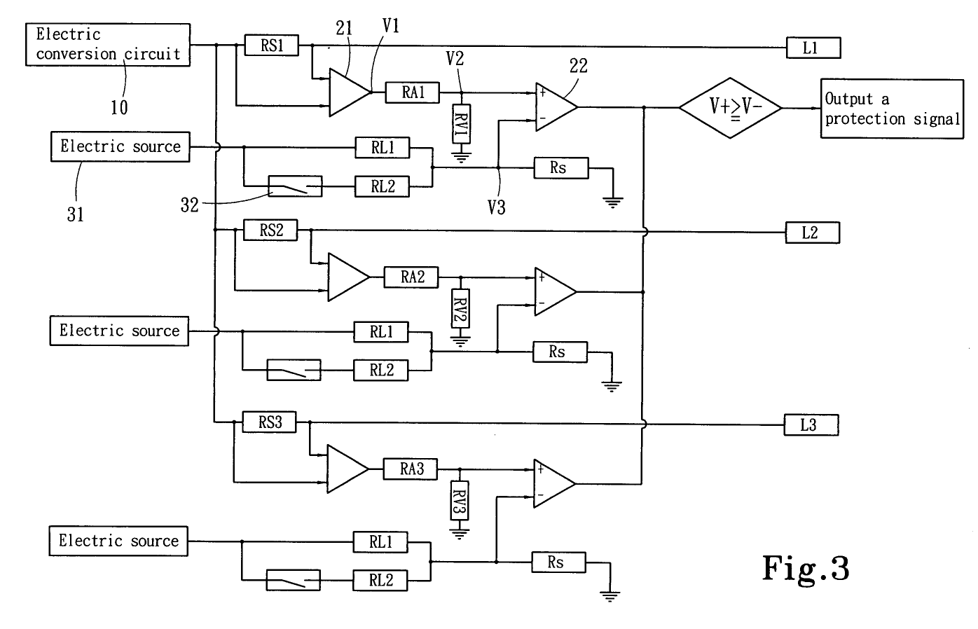

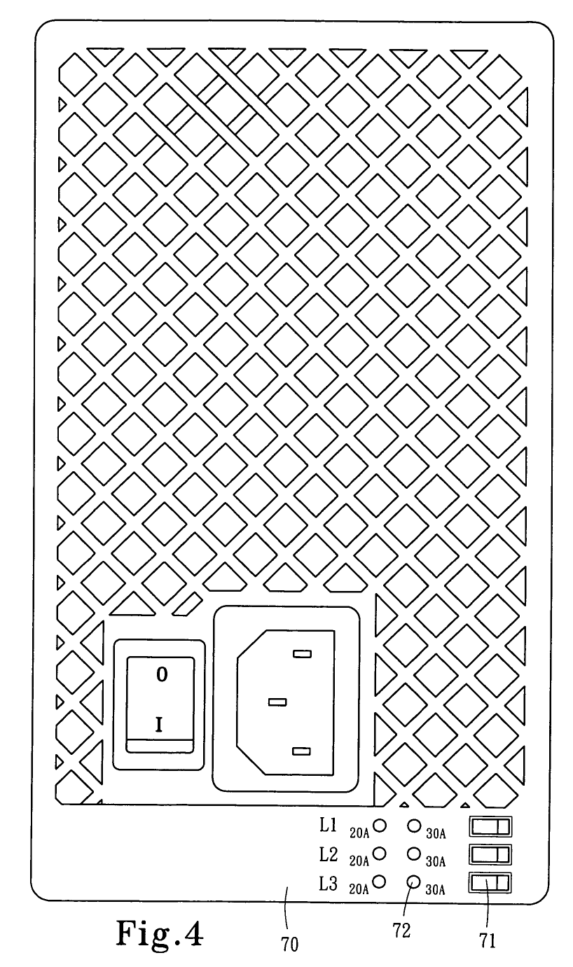

Refer to FIGS. 3 and 4 for another embodiment of the invention. It differs from the previous embodiment by having a power reference circuit 30 on each power protection circuit 20. Users can define individual protection mechanism according to the operation circuit of each set of loads L1-L3. The face plate 70 of the power supply has an indication light 72 and an external switch 71 for each operation circuit to facilitate user selection of the protection mechanism.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A power supply load selection control circuit for a power supply which has at least one electric conversion circuit to output DC to drive at least one load and a power protection circuit connecting to the electric conversion circuit, the DC which drives the load getting a use power value which is compared with a limited power value by the power protection circuit to output a protection signal, wherein:
the limited power value of the power protection circuit is provided by a power reference circuit which includes an electric source to provide reference electricity, a plurality of reference elements ( [symbol] ) connecting to the electric source to generate a plurality of the limited power values and a switch electrically connected to the reference element circuit ( [symbol] ??) to determine the limited power values input to the power protection circuit.

2. The power supply load selection control circuit of claim 1, wherein the electric source has a constant voltage.

3. The power supply load selection control circuit of claim 1, wherein the power protection circuit includes a signal amplifier and a power comparator.

4. The power supply load selection control circuit of claim 3, wherein the electric conversion circuit and the load have a power supply circuit coupled with a resistor in series, the serial resistor having two ends to generate a potential different signal which is amplified by the signal amplifier to detect voltage, the detected voltage being formed the use power value input to a receiving end of the power comparator through a power resistor and a voltage component resistor, the power comparator having another receiving end connecting to the power reference circuit to acquire the limited power value.

5. The power supply load selection control circuit of claim 1, wherein the switch is controlled by an external switch which is located on a face panel of the power supply.

6. The power supply load selection control circuit of claim 1, wherein the switch is a transistor.

7. The power supply load selection control circuit of claim 1, wherein the reference elements are resistors.

8. The power supply load selection control circuit of claim 1, wherein each of the reference elements includes a power resistor and a voltage component resistor.

9. The power supply load selection control circuit of claim 1, wherein the reference elements ( [symbol] ) are connected electrically in a parallel fashion, and at least one of reference element circuits ( [symbol] ) has a switch.

10. The power supply load selection control circuit of claim 7, wherein the reference elements are power resistors sharing a voltage component resistor.
